(19) United States
(12) Patent Application Publication
(10) Pub. No.: US 2012/0001865 A1
(43) Pub. Date: Jan. 5, 2012

(54) LIQUID CRYSTAL DISPLAY HAVING TOUCH INPUT SENSING AND TOUCH SENSING METHOD THEREOF

(76) Inventors: Yung-Chih Chen, Hsin-Chu (TW); Chun-Hsin Liu, Hsin-Chu (TW)

(21) Appl. No.: 13/047,789

(22) Filed: Mar. 14, 2011

(30) Foreign Application Priority Data
Jun. 30, 2010 (TW) 099121427

(51) Int. Cl. G06F 3/045

(52) U.S. Cl. 345/174

(57) ABSTRACT

A liquid crystal display having touch input sensing includes a display panel and sensing units integrated in the display panel. The display panel has scan lines for delivering scan signals and readout lines for delivering readout signals. The sensing unit resets a sensing voltage according to a low-level voltage of the scan signal. Further, the sensing unit pulls up the sensing voltage according to a high-level voltage of the scan signal and an increase of the sensing voltage is under the control of a touch event. The readout signal is generated by the sensing unit based on the sensing voltage and the high-level voltage of the scan signal.

### BACKGROUND OF THE INVENTION

1. Field of the Invention

The present invention relates to display devices, and more particularly to a display having touch input sensing and related method.

2. Description of the Prior Art

Liquid crystal displays (LCDs) have advantages of a thin profile, low power consumption, and low radiation, and are broadly adopted for application in media players, mobile phones, personal digital assistants (PDAs), computer displays, and flat screen televisions. Utilization of LCDs to perform touch input functions has steadily become the mainstream, making application of touch-sensitive LCDs increasingly widespread. Touch-sensitive LCDs employ touch panels, which includes resistive touch panels and capacitive touch panels. Resistive touch panels locate touch input positions through voltage drops, but are unable to provide multitouch input functionality. Capacitive touch panels typically include sense capacitors, and perform signal processing on capacitance variations of the sense capacitors corresponding to touch points to locate touch input positions.

FIG. 1 is a diagram of a touch panel device 100 according to the prior art. As shown in FIG. 1, the touch panel device 100 comprises a touch panel 101, a plurality of readout lines 110, a plurality of sense capacitors 120, a plurality of storage capacitors, and a plurality of comparators 150. When the touch panel 101 is touched, capacitance of a sense capacitor 120 corresponding to a touch point changes, causing capacitor voltage thereof to change. The change in capacitor voltage is transmitted to the corresponding storage capacitor 140 through the corresponding readout line 110, and the corresponding comparator 150 compares the capacitor voltage of the storage capacitor 140 with a reference voltage Vref to generate a touch readout signal Sro. However, as dimensions of the touch panel 101 increase, trace resistance of the readout lines 110 increases, such that the change in capacitor voltage of the sense capacitor 120 transmitted to the storage capacitor 140 experiences a voltage drop due to the trace resistance, causing reduced touch sensitivity. Further, as parasitic capacitance of the readout lines 110 increases with increased size of the touch panel 101, transmission delay of the capacitor voltage from the sense capacitor 120 to the storage capacitor 140 also increases, lowering responsiveness of the touch panel 101. Finally, the touch panel 101 that is externally attached to a display cannot meet the requirements of thin profile, low cost displays having touch sensing functionality.

### SUMMARY OF THE INVENTION

According to an embodiment, a display device having touch input sensing functionality comprises a scan line for transmitting a scanning signal, a sensor electrically connected to the scan line, and a first readout line. The sensor is for providing a first analog readout signal according to the scanning signal, and comprises a first transistor, a first capacitor, a second capacitor, and a second transistor. The first transistor comprises a first terminal, a second terminal, and a gate terminal. The first terminal is electrically connected to the scan line, and the second terminal is electrically connected to the gate terminal. The first capacitor is electrically connected between the scan line and the second terminal of the first transistor. The second capacitor comprises a first terminal and a second terminal. The first terminal of the second capacitor is electrically connected to the second terminal of the first transistor, and the second terminal of the second capacitor is for receiving a common voltage. The second transistor comprises a first terminal, a second terminal, and a gate terminal. The first terminal of the second transistor is electrically connected to the scan line, the gate terminal of the second transistor is electrically connected to the second terminal of the first transistor, and the second terminal of the second transistor is for outputting the first analog readout signal. The first readout line is electrically connected to the second terminal of the second transistor for transmitting the first analog readout signal. Capacitance of the second capacitor changes during a touch event for generating the first analog readout signal corresponding to the touch event.

According to an embodiment, a method of sensing touch input comprises providing a display device having touch input sensing functionality. The display device comprises a scan line for transmitting a scanning signal, a sensor for providing an analog readout signal according to the scanning signal, and a readout line for transmitting the analog readout signal. The method further comprises providing the scanning signal at a low level voltage to the scan line in a first time period, the sensor resetting a sense voltage to the low level voltage according to the scanning signal in the first time period, providing the scanning signal at a high level voltage to the scan line in a second time period, and the sensor pulling up the sense voltage according to the high level voltage of the scanning signal in the second time period. An increased amount of the sense voltage is controlled by a touch event. The method further comprises the sensor feeding the analog readout signal to the readout line according to the sense voltage and the scanning signal at the high level voltage in the second time period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a touch panel device according to the prior art.

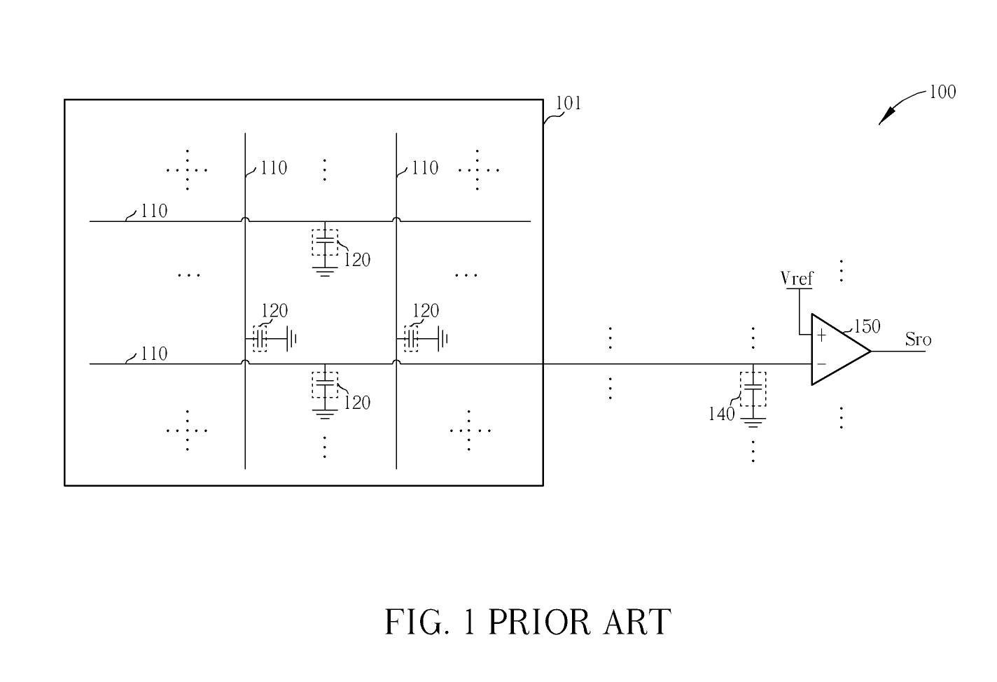

FIG. 2 is a diagram of a display device having touch sensing functionality according to an embodiment.

FIG. 3 is a waveform diagram of signals related to operation of the LCD device of FIG. 2.

FIG. 4 is a diagram of an LCD device having touch sensing functionality according to a second embodiment.

FIG. 5 is a diagram of an LCD device having touch sensing functionality according to a third embodiment.

FIG. 6 is a diagram of an LCD device having touch sensing functionality according to a fourth embodiment.

FIG. 7 is a diagram of an LCD device having touch sensing functionality according to a fifth embodiment.

FIG. 8 is a diagram of an LCD device having touch sensing functionality according to a sixth embodiment.

FIG. 9 is a diagram of an LCD device having touch sensing functionality according to a seventh embodiment.

FIG. 10 is a diagram of an LCD device having touch sensing functionality according to an eight embodiment.

FIG. 11 is a flowchart of a method of performing touch sensing according to an embodiment.

### DETAILED DESCRIPTION

In the following description, a display device having touch sensing functionality and related method are described in their various embodiments with respect to the figures. The embodiments described herein are not intended to limit the claims. Method flowchart step numbers are not intended to limit order of execution, and any executable process that combines the method steps in a way not described herein to generate an equivalent method is within the scope of the disclosure.

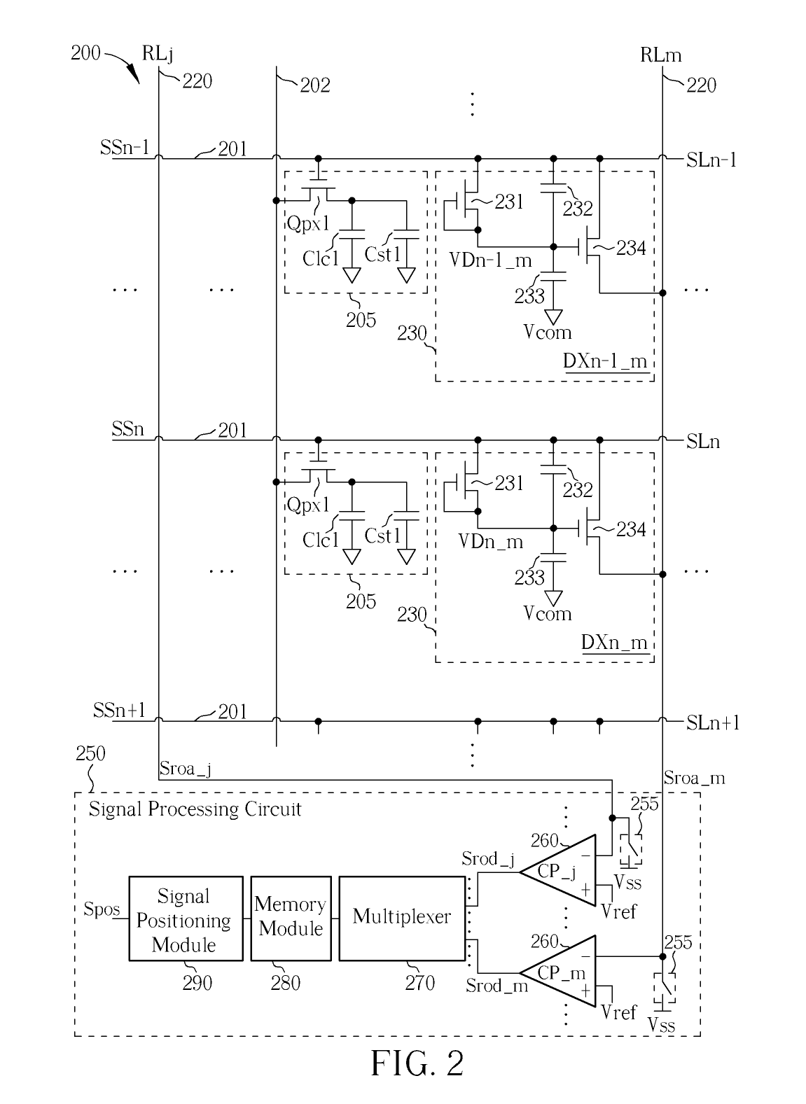

FIG. 2 is a diagram of a display device 200 having touch sensing functionality according to an embodiment. The display device 200 is preferably a liquid crystal display (LCD). As shown in FIG. 2, the display device 200 comprises a plurality of scan lines 201, a plurality of data lines 202, a plurality of pixel modules 205, a plurality of readout lines 220, a plurality of sensors 230, and a signal processing circuit 250. Each scan line 201 is utilized for transmitting a corresponding scanning signal. Each data line 202 is utilized for transmitting a corresponding data signal. Each pixel module 205 comprises a pixel transistor Qpx1, a liquid crystal capacitor Clc1, and a storage capacitor Cst1. The pixel transistor Qpx1 may be a thin film transistor or a field effect transistor, and comprises a first terminal electrically connected to the corresponding data line 202 for receiving the corresponding data signal, a second terminal electrically connected to the liquid crystal capacitor Clc1 and the storage capacitor Cst1, and a gate terminal electrically connected to the corresponding scan line 201 for receiving the corresponding scanning signal. The pixel transistor Qpx1 is utilized for controlling a writing operation of the corresponding data signal according to the corresponding scanning signal. The pixel module 205 outputs a corresponding image signal according to the corresponding data signal written thereto. Each readout line 220 is electrically connected to the plurality of sensors 230 for transmitting a corresponding analog readout signal.

The signal processing circuit 250 comprises a plurality of switches 255, a plurality of comparators 260, a multiplexer 270, a memory module 280, and a signal positioning module 290. Each switch 255 is electrically connected to a corresponding readout line 220 for resetting voltage of the corresponding analog readout signal to a low supply voltage Vss. Each comparator 260 comprises a positive input terminal, a negative input terminal, and an output terminal. The positive input terminal is utilized for receiving the reference voltage Vref. The negative input terminal is electrically connected to the corresponding readout line 220 for receiving the corresponding analog readout signal. The output terminal is electrically connected to the multiplexer 270 for outputting a corresponding digital readout signal generated by comparing the corresponding analog readout signal and the reference voltage Vref. For example, a comparator CP_j is electrically connected to a readout line RLj for comparing an analog readout signal Sroa_j with the reference voltage Vref to generate a digital readout signal Srod_j, and a comparator CP_m is electrically connected to a readout line RLm for comparing an analog readout signal Sroa_m with the reference voltage Vref to generate a digital readout signal Srod_m. In another embodiment, the positive input terminal of the comparator 260 is electrically connected to the corresponding readout line 220 for receiving the corresponding analog readout signal, and the negative input terminal of the comparator 260 is utilized for receiving the reference voltage Vref. The multiplexer 270 is electrically connected to the plurality of comparators 260 for outputting the plurality of digital readout signals generated by the plurality of comparators 260 to the memory module 280 in order. In another embodiment, the positive input terminal of the comparator 260 is electrically connected to the corresponding readout line 220 for receiving the corresponding analog readout signal, and the negative input terminal of the comparator 260 is for receiving the reference voltage Vref. The multiplexer 270 is electrically connected to the plurality of comparators 260 for outputting the plurality of digital readout signals generated by the plurality of comparators 260 in order to the memory module 280. The memory module 280 is electrically connected to the multiplexer 270 for storing the plurality of digital readout signals outputted in order by the multiplexer 270. The signal positioning module 290 is electrically connected to the memory module 280 for generating a touch position signal Spos according to the plurality of digital readout signals.

In the embodiment shown in FIG. 2, each pixel module 205 is adjacent to a sensor 230. In another embodiment, the sensors 230 may be separated by a plurality of scan lines 201 or a plurality of data lines 202, such that not every pixel module 205 is adjacent to a sensor 230. The readout lines 220 may be separated by a plurality of data lines 202. Each sensor 230 comprises a first transistor 231, a first capacitor 232, a second capacitor 233, and a second transistor 234. The first transistor 231 and the second transistor 234 may each be a thin film transistor (TFT) or a field effect transistor (FET). In the following, sensor DXn_m is utilized for illustrating interconnections and circuit functions of each component of the sensors 230.

The first transistor 231 comprises a first terminal electrically connected to the scan line SLn for receiving the scanning signal SSn, a gate terminal, and a second terminal electrically connected to the gate terminal. The first capacitor 232 comprises a first terminal electrically connected to the scan line SLn, and a second terminal electrically connected to the second terminal of the first transistor 231. In a preferred embodiment, the second terminal of the first capacitor 232 is directly coupled to the gate terminal of the first transistor 231 to reduce circuit layout area. The second capacitor 233 comprises a first terminal electrically connected to the second terminal of the first transistor 231, and a second terminal utilized for receiving common voltage Vcom. The second transistor 234 comprises a first terminal electrically connected to the scan line SLn, a second terminal electrically connected to the readout line RLm, and a gate terminal electrically connected to the first terminal of the second capacitor 233 for receiving sense voltage VDn_m. When scanning signal SSn is at the low level voltage, the first transistor 231 is in a conductive state, and thereby resets sense voltage VD_m to the low level voltage. When scanning signal SSn is switched from the low level voltage to the high level voltage, the first transistor 231 switches to an open state, causing sense voltage VDn_m to float, and simultaneously pulling up sense voltage VDn_m through coupling of the first capacitor 232. The sense voltage VDn_m is pulled up according to the following formula:

$$VDn\_m = \frac{C 1 \times Vgh + C 2 \times Vgl}{C 1 + C 2} \qquad ( 1 )$$

In formula (1), C1 is capacitance of the first capacitor 232, C2 is capacitance of the second capacitor 233, Vgh is high level voltage of scanning signal SSn, and Vgl is low level voltage of scanning signal SSn. Capacitance C2 of the second capacitor 233 varies with a touch event, thereby controlling amount of voltage by which sense voltage VDn_m is pulled up. In some embodiments, when a touch event occurs at a panel position corresponding to the sensor DXn_m, the capacitance C2 of the second capacitor 233 increases, thereby lowering amount of voltage by which sense voltage VDn_m is pulled up. In operation of the sensor DXn_m, sense voltage VDn_m is utilized for controlling conducting/open states of the second transistor 234, thereby controlling feeding of the high level voltage of the scanning signal SSn to the readout line RLm for setting voltage of analog readout signal Sroa_m. Thus, effectiveness of sense voltage VDn_m is not reduced by increased trace resistance of the readout line RLm, and touch sensitivity of the sensor DXn_m is not reduced by increases in trace resistance of the readout line RLm. Further, because the sensor 230 is integrated into the display panel comprising the pixel module 205, the LCD device 200 may have a thinner exterior, and manufacturing costs are lowered.

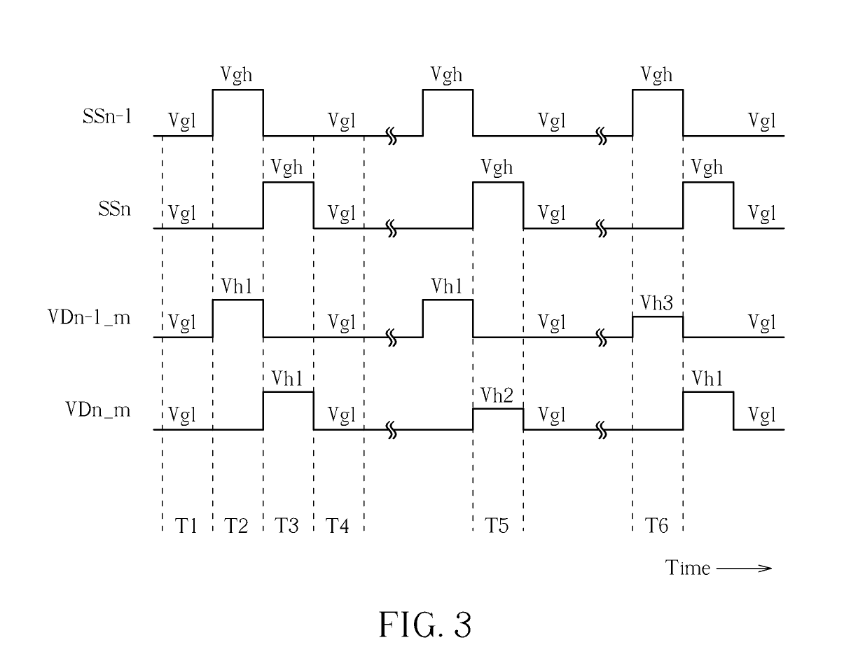

FIG. 3 is a waveform diagram of signals related to operation of the LCD device 200 of FIG. 2 where the horizontal axis represents time. In FIG. 3, from top to bottom, the signals include scanning signal SSn-1, scanning signal SSn, sense voltage VDn-1_m, and sense voltage VDn_m. As shown in FIG. 3, in a time period T1, scanning signal SSn-1 and scanning signal SSn are both at the low level voltage Vgl, so sense voltage VDn-1_m and sense voltage VDn_m are both reset to the low level voltage Vgl. In time period T2, scan line voltage SSn-1 switches from low level voltage Vgl to high level voltage Vgh, so sensor DXn-1_m pulls sense voltage VDn-1m up to first high voltage Vh1 through coupling of its first capacitor 232. In time period T3, scanning signal SSn switches from the low level voltage Vgl to the high level voltage Vgh, so the sensor DXn_m pulls sense voltage VDn_m up to the first high voltage Vh1 through coupling of its first capacitor 232. In time period T4, scanning signal SSn-1 and scanning signal SSn are both at the low level voltage Vgl, so sense voltage VDn-1_m and sense voltage VDn_m are reset to the low level voltage Vgl again.

In time period T5, scanning signal SSn switches from the low level voltage Vgl to the high level voltage Vgh. At this time, because a first touch event occurs at a panel position corresponding to sensor DXn_m, capacitance of the second capacitor 233 of the sensor DXn_m increases, so that sense voltage VDn_m is pulled up to a second high voltage Vh2 lower than the first high voltage Vh1. The second transistor 234 of the sensor DXn_m outputs analog readout signal Sroa_m corresponding to the first touch event according to the second high voltage Vh2, such that the signal processing circuit 250 may generate touch position signal Spos corresponding to the first touch event accordingly. In time period T6, scanning signal SSn-1 switches from the low level voltage Vgl to the high level voltage Vgh. At this time, because a second touch event occurs at a panel position corresponding to the sensor DXn-1_m, causing capacitance of the second capacitor 233 of the sensor DXn-1_m to increase, sense voltage VDn-1_m is pulled up to a third high voltage Vh3 lower than the first high voltage Vh1, and the second transistor 234 of the sensor DXn-1_m outputs analog readout signal Sroa_m corresponding to the second touch event according to the third high voltage Vh3, such that the signal processing circuit 250 may generate touch position signal Spos corresponding to the second touch event accordingly.

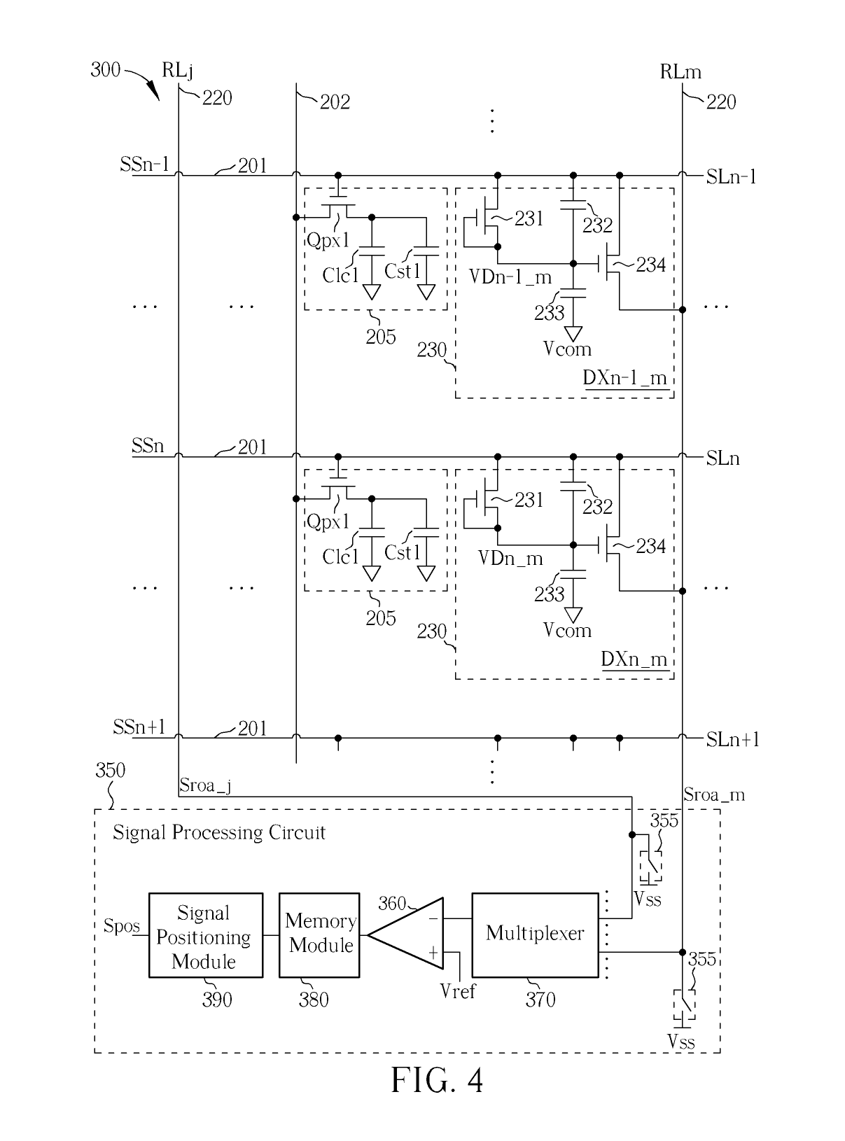

FIG. 4 is a diagram of an LCD device having touch sensing functionality according to a second embodiment. As shown in FIG. 4, an LCD device 300 is similar to the LCD device 200 shown in FIG. 2, differing primarily in comprising a signal processing circuit 350 instead of the signal processing circuit 250. The signal processing circuit 350 comprises a plurality of switches 355, a multiplexer 370, a comparator 360, a memory module 380, and a signal positioning module 390. Each switch 355 is electrically connected to a corresponding readout line 220 for resetting voltage of a corresponding analog readout signal to low source voltage Vss. The multiplexer 370 is electrically connected to the plurality of readout lines 220 for outputting the plurality of analog readout signals in order to the comparator 360. Please note that the multiplexer 270 shown in FIG. 2 is a digital multiplexer, whereas the multiplexer 370 is an analog multiplexer. The comparator 360 comprises a positive input terminal utilized for receiving reference voltage Vref, a negative input terminal electrically connected to the multiplexer 370 for receiving the analog readout signals in order, and an output terminal electrically connected to the memory module 380 for outputting digital readout signals generated by comparing the analog readout signals with the reference voltage Vref. In another embodiment, the positive input terminal of the comparator 360 is electrically connected to the multiplexer 370 for receiving the analog readout signals in order, and the negative input terminal of the comparator 360 is utilized for receiving the reference voltage Vref. The memory module 380 is electrically connected to the comparator 360 for storing the digital readout signals generated in order by the comparator 360. The signal positioning module 390 is electrically connected to the memory module 380 for generating touch position signal Spos according to the plurality of digital readout signals. Other functions of the LCD device 300 are similar to those of the LCD device 200, and are not described again here.

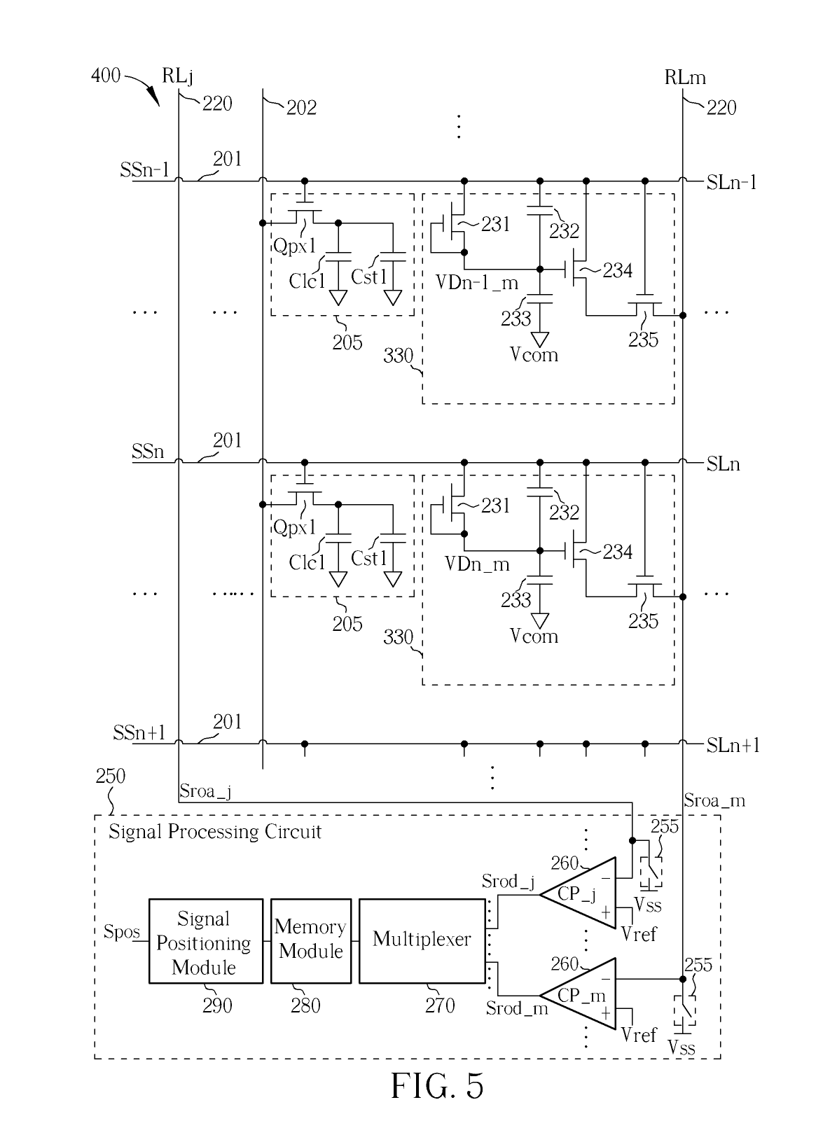

FIG. 5 is a diagram of an LCD device 400 having touch sensing functionality according to a third embodiment. As shown in FIG. 5, the LCD device 400 is similar to the LCD device 200 shown in FIG. 2, differing primarily in comprising a plurality of sensors 330 instead of the plurality of sensors 230. Each sensor 330 has internal structure similar to that of the sensors 230 shown in FIG. 2, differing primarily in that each sensor 330 further comprises a third transistor 235 for controlling output of analog readout signals according to the corresponding scanning signal. The third transistor 235 comprises a first terminal electrically connected to the second terminal of the second transistor 234, a second terminal electrically connected to the readout line 220, and a gate terminal electrically connected to the scan line 201 for receiving the scanning signal. The third transistor 235 may be a TFT or a FET. When the scanning signal is at the low level voltage, the third transistor 235 is in the open state to disable output of the analog readout signal. At this time, the third transistor 235 is utilized for aiding the second transistor 234 in stopping output of the analog readout signal. When the scanning signal is at the high level voltage, the third transistor 235 is in the conducting state for enabling output of the analog readout signal. Other functions of the LCD device 400 are similar to those of the LCD device 200, and are not described again.

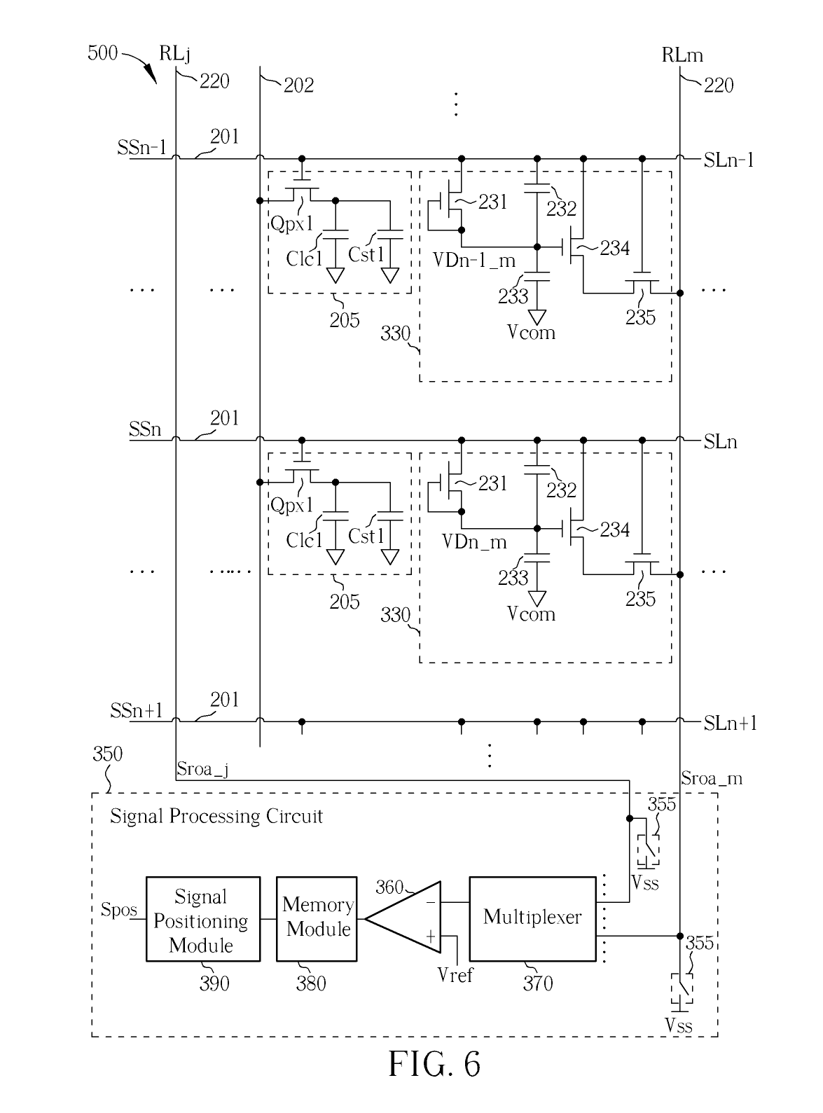

FIG. 6 is a diagram of an LCD device 500 having touch sensing functionality according to a fourth embodiment. The LCD device 500 shown in FIG. 6 is similar to the LCD device 400 shown in FIG. 5, differing primarily in comprising the signal processing circuit 350 instead of the signal processing circuit 250. Structure and functionality of the signal processing circuit 350 are described in detail in the above description of the LCD device 300, and are not repeated here.

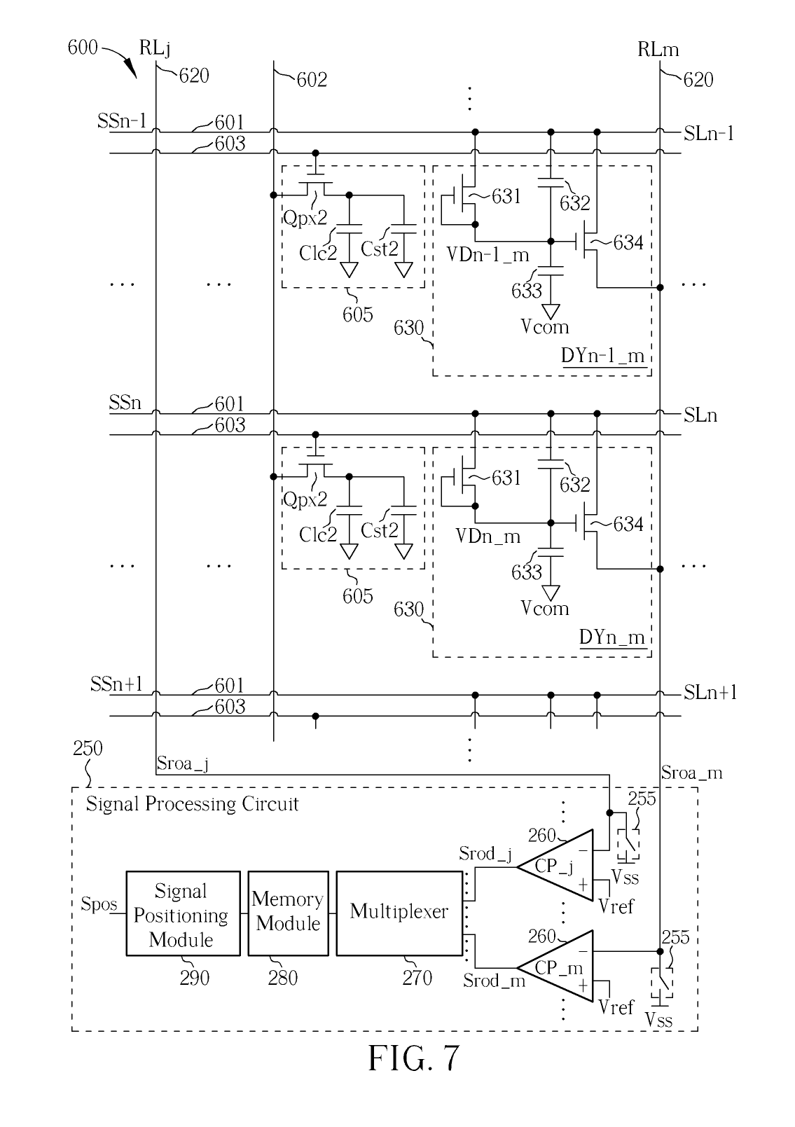

FIG. 7 is a diagram of an LCD device 600 having touch sensing functionality according to a fifth embodiment. The LCD device 600 comprises a plurality of scan lines 601, a plurality of data lines 602, a plurality of gate lines 603, a plurality of pixel modules 605, a plurality of readout lines 620, a plurality of sensors 630, and the signal processing circuit 250. Each scan line 601 is utilized for transmitting a corresponding scanning signal. Each data line 602 is utilized for transmitting a corresponding data signal. Each gate line 603 is utilized for transmitting a corresponding gate signal. Please note that frequency of the gate signals may be the same or different from frequency of the scanning signals, high level voltage of the gate signals may be the same or different from high level voltage of the scanning signals, and low level voltage of the gate signals may be the same or different from low level voltage of the scanning signals. Each pixel module 605 comprises a pixel transistor Qpx2, a liquid crystal capacitor Clc2, and a storage capacitor Cst2. The pixel transistor Qpx2 may be a TFT or a FET. The pixel transistor Qpx2 comprises a first terminal electrically connected to the corresponding data line 602 for receiving the corresponding data signal, a second terminal electrically connected to the liquid crystal capacitor Clc2 and the storage capacitor Cst2, and a gate terminal electrically connected to the corresponding gate line 603 for receiving the corresponding gate signal. The pixel transistor Qpx2 is utilized for controlling writing operations of the corresponding data signal according to the corresponding gate signal. The pixel module 605 outputs a corresponding image signal according to the corresponding data signal written thereto. Each readout line 620 is electrically connected to a plurality of corresponding sensors 630 for transmitting the corresponding analog readout signal. Structure and functions of the signal processing circuit 250 are described above in the detailed description of the LCD device 200, and are not repeated here.

In the embodiment shown in FIG. 7, each pixel module 605 neighbors a corresponding sensor 630. In another embodiment, the sensors 630 may be separated by a plurality of gate lines 603, or may be separated by a plurality of data lines 602. Namely, each pixel module 605 may not neighbor a sensor 630. The scan lines 601 may be separated by a plurality of gate lines 603, and the readout lines 620 may be separated be a plurality of data lines 602. Each sensor 630 comprises a first transistor 631, a first capacitor 632, a second capacitor 633, and a second transistor 634. The first transistor 631 may be a TFT or a FET, and the second transistor 634 may be a TFT or a FET.

In the following description, reference is made to a sensor DYn_m for describing interconnections and circuit functions of the various components shown in FIG. 7. The first transistor 631 comprises a first terminal electrically connected to a scan line SLn for receiving scanning signal SSn, a gate terminal, and a second terminal electrically connected to the gate terminal. The first capacitor 632 comprises a first terminal electrically connected to the scan line SLn and a second terminal electrically connected to the second terminal of the first transistor 631. In a preferred embodiment, the second terminal of the first capacitor 632 is directly coupled to the gate terminal of the first transistor to reduce circuit layout area. The second capacitor 633 comprises a first terminal electrically connected to the second terminal of the first transistor 631 and a second terminal utilized for receiving common voltage Vcom. The second transistor 634 comprises a first terminal electrically connected to the scan line SLn, a second terminal electrically connected to the readout line RLm, and a gate terminal electrically connected to the first terminal of the second capacitor 633 for receiving sense voltage VDn_m. Functions of the first transistor 631, the first capacitor 632, the second capacitor 633 and the second transistor 634 are similar to the functions of the first transistor 231, the first capacitor 232, the second capacitor 233 and the second transistor 234 shown in FIG. 2, so touch sensitivity of the sensor DYn_m is not decreased by an increase in the trace resistance of the readout line RLm. Further, because the sensor 630 is integrated into the display panel comprising the pixel module 605, the LCD device 600 may have a thinner exterior, and manufacturing cost thereof may be lowered.

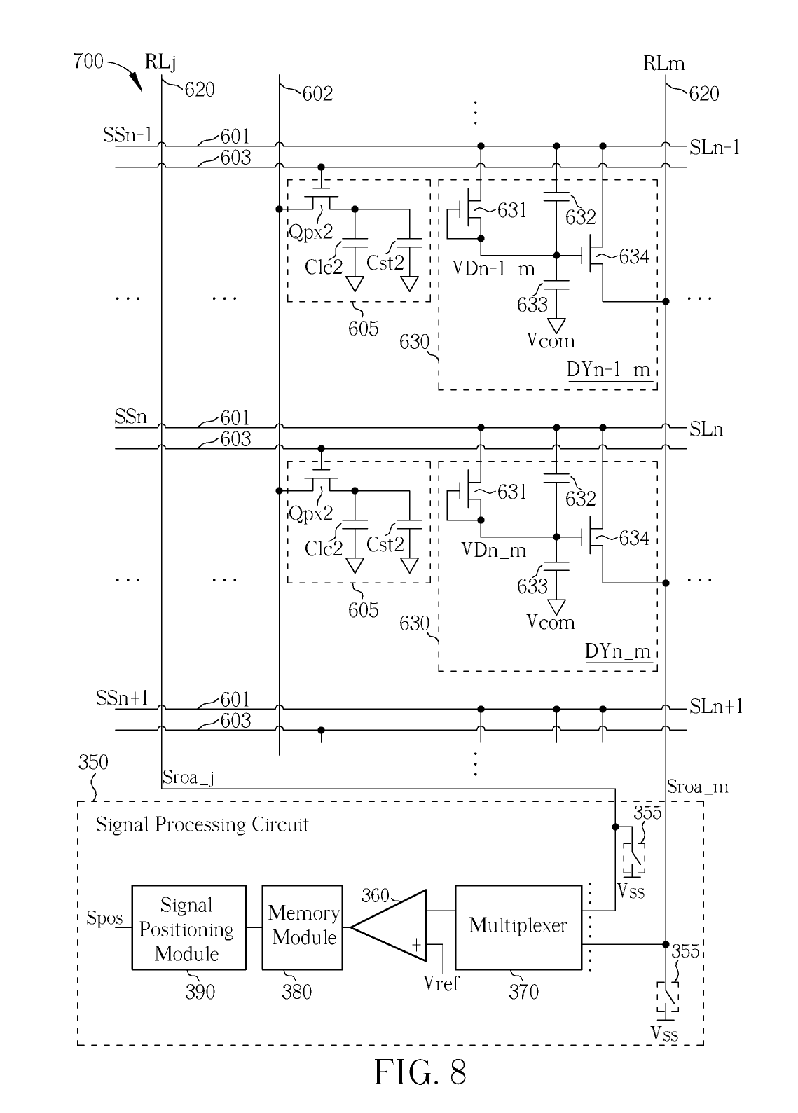

FIG. 8 is a diagram of an LCD device 700 having touch sensing functionality according to a sixth embodiment. The LCD device 700 shown in FIG. 8 is similar to the LCD device 600 shown in FIG. 7, differing primarily in comprising the signal processing circuit 350 instead of the signal processing circuit 250. Structure and functions of the signal processing circuit 350 are described in detail above in the description of the LCD device 300, and are not repeated here.

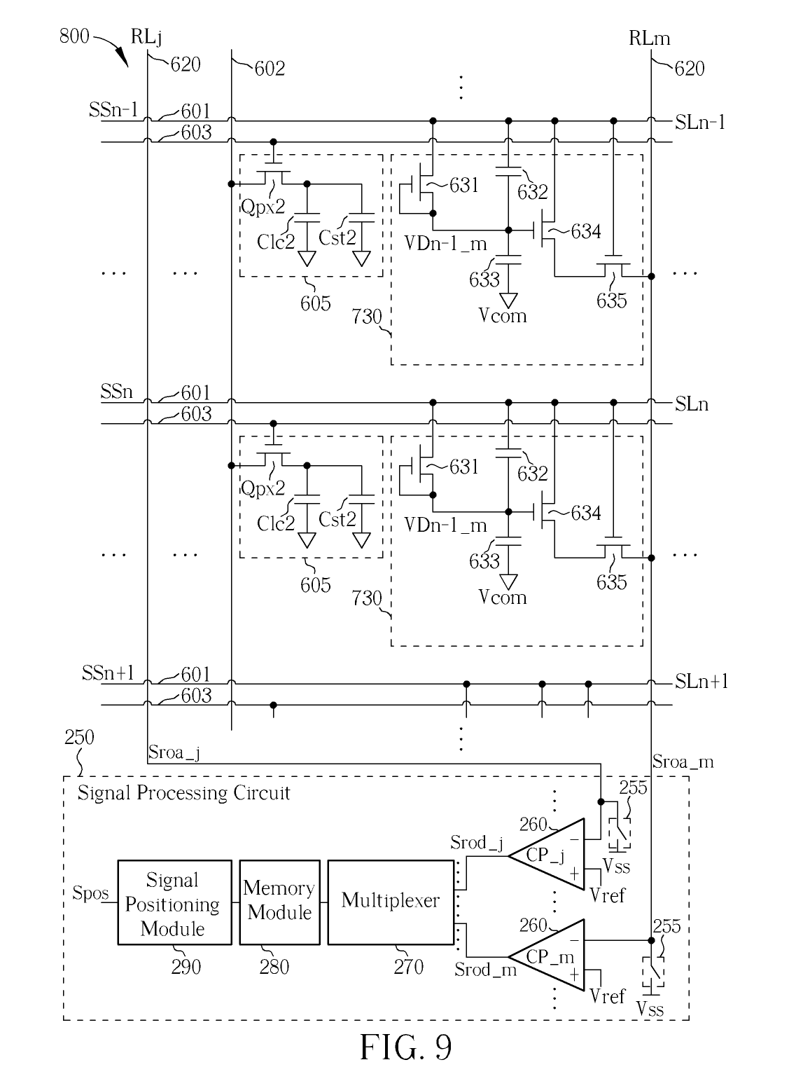

FIG. 9 is a diagram of an LCD device 800 having touch sensing functionality according to a seventh embodiment. As shown in FIG. 9, the LCD device 800 is similar to the LCD device 600 shown in FIG. 7, differing primarily in comprising a plurality of sensors 730 instead of the plurality of sensors 630. Structure of the sensors 730 is similar to that of the sensors 630 shown in FIG. 7, differing primarily in further comprising a third transistor 635 for controlling output of analog readout signals according to a scanning signal. The third transistor 635 comprises a first terminal electrically connected to the second terminal of the second transistor 634, a second terminal electrically connected to the readout line 620, and a gate terminal electrically connected to the scan line 601 for receiving the scanning signal. The third transistor 635 may be a TFT or a FET. When the scanning signal is at the low level voltage, the third transistor 635 is in the open state to disable output of the analog readout signal. At this time, the third transistor 635 is utilized for aiding the second transistor 634 in stopping output of the analog readout signal. When the scanning signal is at the high level voltage, the third transistor 635 is in the conducting state for enabling output of the analog readout signal. Other functions of the LCD device 800 are similar to those of the LCD device 600, and are not described again.

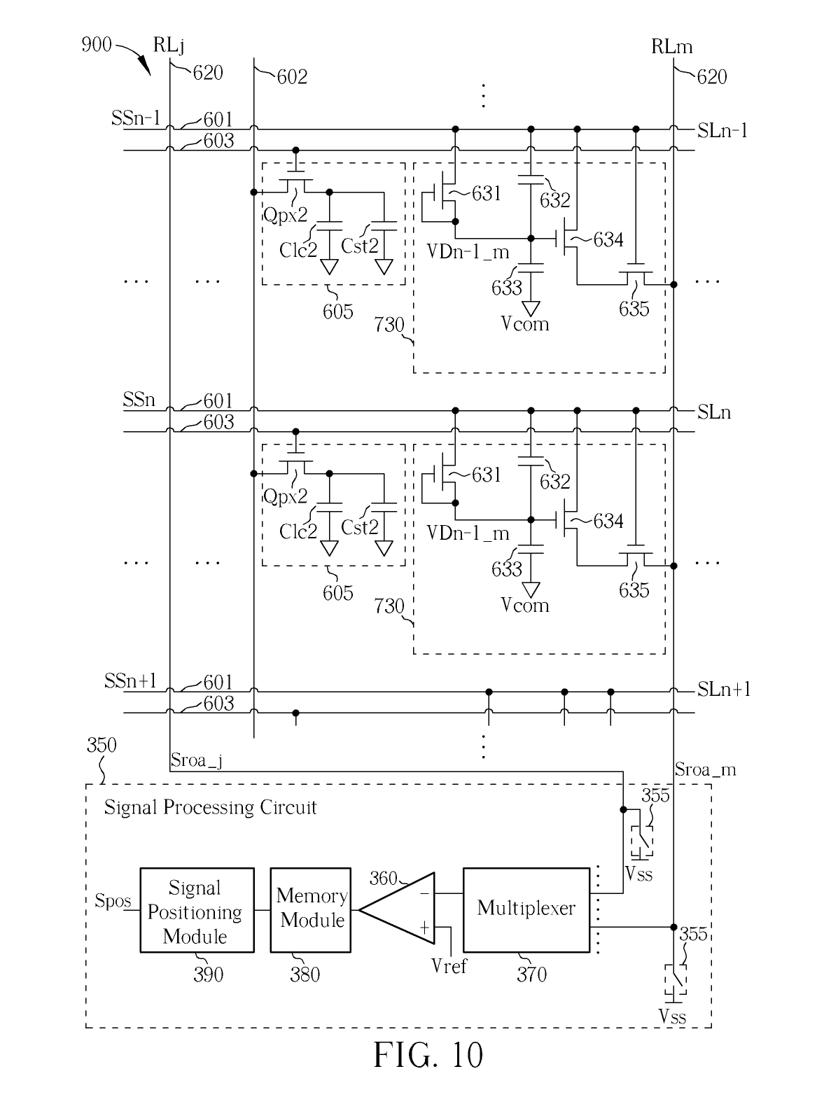

FIG. 10 is a diagram of an LCD device 900 having touch sensing functionality according to an eight embodiment. As shown in FIG. 10, the LCD device 900 is similar to the LCD device 800 shown in FIG. 9, differing primarily in comprising the signal processing circuit 350 instead of the signal processing circuit 250. Structure and functions of the signal processing circuit 350 are described above in the description of the LCD device 300, and are not described again here.

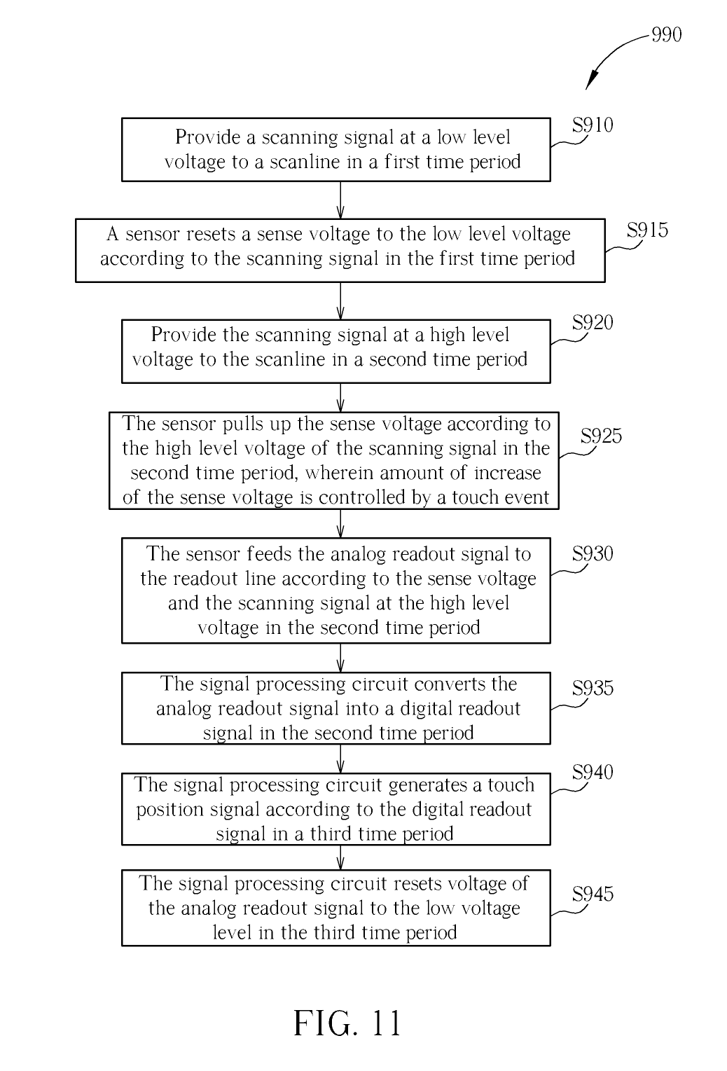

FIG. 11 is a flowchart of a method of performing touch sensing according to an embodiment. A process 990 shown in FIG. 11 illustrates the method based on the first through eighth embodiments of the LCD device 200-900. The process 990 comprises the following steps:

Step S910: Provide a scanning signal at a low level voltage to a scan line in a first time period;

Step S915: A sensor resets a sense voltage to the low level voltage according to the scanning signal in the first time period;

Step S920: Provide the scanning signal at a high level voltage to the scan line in a second time period;

Step S925: The sensor pulls up the sense voltage according to the high level voltage of the scanning signal in the second time period, wherein amount of increase of the sense voltage is controlled by a touch event;

Step S930: The sensor feeds the analog readout signal to the readout line according to the sense voltage and the scanning signal at the high level voltage in the second time period;

Step S935: The signal processing circuit converts the analog readout signal into a digital readout signal in the second time period;

Step S940: The signal processing circuit generates a touch position signal according to the digital readout signal in a third time period; and

Step S945: The signal processing circuit resets voltage of the analog readout signal to the low voltage level in the third time period.

In the above process 990, the sensor may disable output of the analog readout signal according to the low level voltage of the scanning signal in the first time period, and may enable output of the analog readout signal according to the high level voltage of the scanning signal in the second time period.

In the embodiments described above, for operation of the sensors of the LCD devices, the sense voltage is utilized for controlling conduction/open states of the second transistor of the sensor, thereby controlling feeding of the high level voltage of the scanning signal to the readout line for setting the voltage of the analog readout signal. Thus, the effect of the sense voltage is not diminished due to increased trace resistance of the readout line, meaning the touch sensitivity is not lowered due to the increased trace resistance of the readout line. Further, the sensors of the LCD devices are integrated into the display panel comprising the pixel module, giving the LCD devices a thinner exterior, and lowering manufacturing costs.

Those skilled in the art will readily observe that numerous modifications and alterations of the device and method may be made while retaining the teachings of the invention.

What is claimed is:

1. A display device having touch input sensing functionality, the display device comprising:
a scan line for transmitting a scanning signal;
a sensor electrically connected to the scan line for providing a first analog readout signal according to the scanning signal, the sensor comprising:
a first transistor comprising a first terminal, a second terminal, and a gate terminal, wherein the first terminal is electrically connected to the scan line, and the second terminal is electrically connected to the gate terminal;
a first capacitor electrically connected between the scan line and the second terminal of the first transistor;
a second capacitor comprising a first terminal and a second terminal, wherein the first terminal of the second capacitor is electrically connected to the second terminal of the first transistor, and the second terminal of the second capacitor is for receiving a common voltage; and
a second transistor comprising a first terminal, a second terminal, and a gate terminal, wherein the first terminal of the second transistor is electrically connected to the scan line, the gate terminal of the second transistor is electrically connected to the second terminal of the first transistor, and the second terminal of the second transistor is for outputting the first analog readout signal; and
a first readout line electrically connected to the second terminal of the second transistor for transmitting the first analog readout signal;
wherein capacitance of the second capacitor changes during a touch event for generating the first analog readout signal corresponding to the touch event.

2. The display device of claim 1, wherein the first transistor and the second transistor are thin-film transistors or field effect transistors.

3. The display device of claim 1, wherein the sensor further comprises:
a third transistor comprising a first terminal, a second terminal, and a gate terminal, wherein the first terminal of the third transistor is electrically connected to the second terminal of the second transistor, the gate terminal of the third transistor is electrically connected to the scan line, and the second terminal of the third transistor is electrically connected to the first readout line.

4. The display device of claim 3, wherein the third transistor is a thin-film transistor or a field effect transistor.

5. The display device of claim 1, further comprising:
a second readout line for transmitting a second analog readout signal;
a first switch electrically connected to the first readout line for resetting voltage of the first analog readout signal to a low supply voltage;
a second switch electrically connected to the second readout line for resetting voltage of the second analog readout signal to the low supply voltage;
a first comparator electrically connected to the first readout line for comparing the first analog readout signal and a reference voltage to generate a first digital readout signal; and
a second comparator electrically connected to the second readout line for comparing the second analog readout signal and the reference voltage to generate a second digital readout signal.

6. The display device of claim 5, further comprising:
a multiplexer electrically connected to the first comparator and the second comparator for outputting the first digital readout signal and the second digital readout signal in order;
a memory module electrically connected to the multiplexer for storing the first digital readout signal and the second digital readout signal outputted in order by the multiplexer; and
a signal positioning module electrically connected to the memory module for generating a touch position signal according to the first digital readout signal and the second digital readout signal.

7. The display device of claim 1, further comprising:
a second readout line for transmitting a second analog readout signal;
a first switch electrically connected to the first readout line for resetting voltage of the first analog readout signal to a low supply voltage;
a second switch electrically connected to the second readout line for resetting voltage of the second analog readout signal to the low supply voltage;
a multiplexer electrically connected to the first readout line and the second readout line for outputting the first analog readout signal and the second analog readout signal in order; and
a comparator electrically connected to the multiplexer for comparing the first analog readout signal and a reference voltage to generate a first digital readout signal, and for comparing the second analog readout signal to the reference voltage to generate a second digital readout signal.

8. The display device of claim 7, further comprising:
a memory module electrically connected to the comparator for storing the first digital readout signal and the second digital readout signal generated in order by the comparator; and
a signal positioning module electrically connected to the memory module for generating a touch position signal according to the first digital readout signal and the second digital readout signal.

9. The display device of claim 1, further comprising:
a data line for transmitting a data signal; and
a pixel module electrically connected to the scan line and the data line for outputting an image signal according to the scanning signal and the data signal.

10. The display device of claim 9, wherein the pixel module comprises:
a pixel transistor comprising a first terminal, a second terminal, and a gate terminal, wherein the first terminal of the pixel transistor is electrically connected to the data line for receiving the data signal, and the gate terminal of the transistor is electrically connected to the scan line for receiving the scanning signal;
a liquid crystal capacitor electrically connected to the second terminal of the pixel transistor; and
a storage capacitor electrically connected to the second terminal of the pixel transistor.

11. The display device of claim 1, further comprising:
a gate line for transmitting a gate signal;
a data line for transmitting a data signal; and
a pixel module electrically connected to the gate line and the data line for outputting an image signal according to the gate signal and the data signal.

12. The display device of claim 11, wherein the pixel module comprises:
a pixel transistor comprising a first terminal, a second terminal, and a gate terminal, wherein the first terminal of the pixel transistor is electrically connected to the data line for receiving the data signal, and the gate terminal of the transistor is electrically connected to the gate line for receiving the gate signal;
a liquid crystal capacitor electrically connected to the second terminal of the pixel transistor; and
a storage capacitor electrically connected to the second terminal of the pixel transistor.

13. The display device of claim 11, wherein frequency of the gate signal is different from frequency of the scanning signal.

14. The display device of claim 11, wherein high level voltage of the gate signal is different from high level voltage of the scanning signal.

15. The display device of claim 11, wherein low level voltage of the gate signal is different from low level voltage of the scanning signal.

16. A method of sensing touch input, the method comprising:
providing a display device having touch input sensing functionality, the display device comprising:
a scan line for transmitting a scanning signal;
a sensor for providing an analog readout signal according to the scanning signal; and
a readout line for transmitting the analog readout signal;
providing the scanning signal at a low level voltage to the scan line in a first time period;
the sensor resetting a sense voltage to the low level voltage according to the scanning signal in the first time period;
providing the scanning signal at a high level voltage to the scan line in a second time period;
the sensor pulling up the sense voltage according to the high level voltage of the scanning signal in the second time period, wherein an increased amount of the sense voltage is controlled by a touch event; and
the sensor feeding the analog readout signal to the readout line according to the sense voltage and the scanning signal at the high level voltage in the second time period.

17. The method of claim 16, wherein the display device further comprises a signal processing circuit, the method further comprising:
the signal processing circuit converting the analog readout signal into a digital readout signal in the second time period;
the signal processing circuit generating a touch position signal according to the digital readout signal in a third time period; and
the signal processing circuit resetting voltage of the analog readout signal to the low voltage level in the third time period.

18. The method of claim 16, further comprising:
the sensor disabling output of the analog readout signal according to the scanning signal at the low level voltage in the first time period; and
the sensor enabling output of the analog readout signal according to the scanning signal at the high level voltage in the second time period.
